(19) United States
(12) Patent Application Publication
(10) Pub. No.: US 2025/0232764 A1
(43) Pub. Date: Jul. 17, 2025

(54) CONTEXT-BASED VIDEO TRANSCRIPTION SYSTEM USING MACHINE LEARNING

(71) Applicant: Cisco Technology, Inc., San Jose, CA (US)

(72) Inventors: Jieyu Tan, Zhejiang (CN); Han Hu, Hanzhou City, Zhejiang Province (CN); Siyuan Li, Zhejiang (CN); Yifei Liu, Zhejiang (CN)

(21) Appl. No.: 18/411,379

(22) Filed: Jan. 12, 2024

(51) Int. Cl. G10L 15/183; G06V 20/40; G06V 20/62; G06V 40/16; G10L 15/18; G10L 15/25; G10L 25/57

(52) U.S. Cl. CPC G10L 15/183; G06V 20/46; G06V 20/63; G06V 40/172; G10L 15/1815; G10L 15/25; G10L 25/57

(57) ABSTRACT

A method, computer system, and computer program product are provided for generating transcriptions of multimedia data using a context-based machine learning model. Multimedia data including video data and audio data associated with the video data is analyzed to identify one or more features in the video data. One or more candidate words are obtained based on the one or more features identified in the video data. A particular candidate word of the one or more candidate words is determined to match a particular utterance in the audio data. The particular candidate word is selected for the particular utterance based on the audio data.

### TECHNICAL FIELD

The present disclosure relates generally to automatic speech recognition.

### BACKGROUND

Automatic speech recognition refers to various technologies that convert spoken language into written text. Video conferencing software may employ automatic speech recognition solutions in order to automatically generate subtitles or transcripts for videos, which can be performed quickly enough to provide captions in near-real-time for live video content. However, while the accuracy of such models has generally improved, conventional solutions fail to accurately transcribe certain words or phrases, including many loan words, proper nouns, jargon, acronyms, and the like.

### BRIEF DESCRIPTION OF THE DRAWINGS

FIG. 1 is a block diagram depicting a network environment for performing automatic speech recognition in communication sessions, according to an example embodiment.

FIG. 2 is a flow diagram for an automatic speech recognition model that generates transcripts, according to an example embodiment.

FIG. 3 is a diagram depicting video content that is analyzed according to an example embodiment.

FIG. 4 is a flow chart of a method for performing automatic speech recognition with respect to multimedia data, according to an example embodiment.

FIG. 5 is a flow chart of a method for mapping utterances to text, according to an example embodiment.

FIGS. 6A and 6B are diagrams depicting image data corresponding to different multimedia data samples, according to an example embodiment.

FIG. 7 is a block diagram of a device that may be configured to perform operations relating to automatic speech recognition, as presented herein.

### DETAILED DESCRIPTION

### Overview

According to one embodiment, techniques are provided for generating transcriptions of multimedia data, and more specifically, for a context-based video transcription system that uses machine learning. Multimedia data including video data and audio data associated with the video data is analyzed to identify one or more features in the video data. One or more candidate words are obtained based on the one or more features identified in the video data. A particular candidate word of the one or more candidate words is determined to match a particular utterance in the audio data. The particular candidate word is selected for the particular utterance based on the audio data.

### Example Embodiments

Present embodiments relate to automatic speech recognition, and more specifically, to a context-based video transcription system that uses machine learning. Speech-to-text transcription is an important feature in various software applications such as video conferencing applications. Conventional approaches to speech-to-text transcription analyze audio data to generate a transcript. Some approaches consider the context of words in relation to other words, such as selecting the word “ewe” instead of “you” if a nearby word is “sheep.” However, conventional solutions do not consider the full context when generating transcripts for multimedia data samples, causing some utterances to erroneously be transcribed. A few examples include proper nouns that sound like other words (e.g., “Lennon” being transcribed as “linen”), abbreviations (e.g., “inc.” being transcribed as “ink”), technical jargon, domain-specific terminology, and the like. Thus, conventional solutions for automatic speech recognition will have much higher error rates than the embodiments presented herein, particular in regard to certain subject matter areas.

To address this problem, the embodiments presented herein provide an improved approach to automatic speech recognition that processes the video portion of multimedia data as well as the audio portion in order to obtain a context for utterances in the audio portion. Specifically, people, objects, text, and other indicators can be derived from the video portion in order to provide a machine learning model with a better context for selecting words to match utterances in the audio data. Further, the extent to which contextual indicators in the video data are deemed relevant can be used to increase the likelihood that an automatic speech recognition model will correctly map words related to those indicators to the utterances. For example, if a video includes text, words having a larger font size than other words may be considered to be more likely candidates for utterances.

Thus, present embodiments improve the technical field of automatic speech recognition by performing a multifaceted analysis of the video portion of multimedia content in order to more accurately select words to map to utterances found in the corresponding audio portion of the multimedia content. The machine learning models used herein can be iteratively retrained based on user feedback, further improving the functionality of the machine learning models by enhancing the accuracy of the present embodiments. Thus, present embodiments provide the practical application of improving automatic speech recognition by reducing the error rate of transcriptions in a manner that extends consideration to the full context of multimedia content.

It should be noted that references throughout this specification to features, advantages, or similar language herein do not imply that all of the features and advantages that may be realized with the embodiments disclosed herein should be, or are in, any single embodiment. Rather, language referring to the features and advantages is understood to mean that a specific feature, advantage, or characteristic described in connection with an embodiment is included in at least one embodiment. Thus, discussion of the features, advantages, and similar language, throughout this specification may, but do not necessarily, refer to the same embodiment.

Furthermore, the described features, advantages, and characteristics may be combined in any suitable manner in one or more embodiments. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages will become more fully apparent from the following drawings, description, and appended claims, or may be learned by the practice of embodiments as set forth hereinafter.

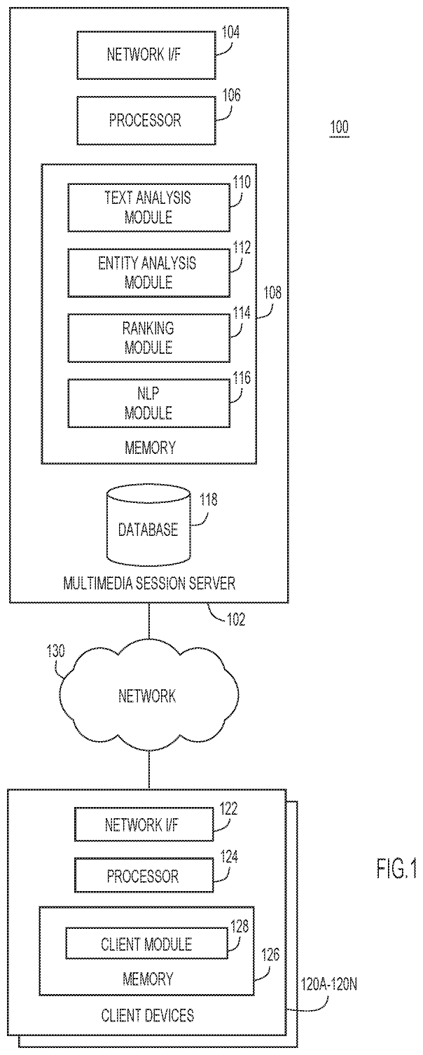

With reference now to FIG. 1, a block diagram is presented depicting a network environment 100 for performing automatic speech recognition in communication sessions, according to an example embodiment. As depicted, network environment 100 includes a multimedia session server 102 and a plurality of client devices 120A-120N that are in communication via a network 130. It is to be understood that the functional division among components have been chosen for purposes of explaining various embodiments and is not to be construed as a limiting example.

Multimedia session server 102 includes a network interface (I/F) 104, at least one processor (computer processor) 106, memory 108 (which stores instructions for a text analysis module 110, an entity analysis module 112, a ranking module 114, and a natural language processing (NLP) module 116), and a database 118. In various embodiments, multimedia session server 102 may include a rack-mounted server, laptop, desktop, smartphone, tablet, or any other programmable electronic device capable of executing computer readable program instructions. Network interface 104 may be a network interface card that enables components of multimedia session server 102 to send and receive data over a network, such as network 130. Multimedia session server 102 may perform automatic speech recognition with respect to multimedia content, such as live communication sessions, prerecorded content, other live-streaming content, and the like.

Text analysis module 110, entity analysis module 112, ranking module 114, and NLP module 116 may include one or more modules or units to perform various functions of the embodiments described below. Text analysis module 110, entity analysis module 112, ranking module 114, and NLP module 116 may be implemented by any combination of any quantity of software and/or hardware modules or units, and may reside within memory 108 of multimedia session server 102 for execution by a processor, such as processor 106.

Initially, the multimedia data that is analyzed by multimedia session server 102 may include any data having a video component and a corresponding audio component, such as a presentation, a televised event, a collaboration session between users, and the like. The multimedia data can include live or prerecorded content. A few examples, which are not to be construed as limiting, include a video conference between multiple users, a slideshow presentation in which a presenter discusses a topic to participants, a sporting event with one or more individuals providing commentary, a live news stream presented by a news anchor, and the like. The multimedia data can be obtained via network 130 from any network-accessible source, such as the Internet, a local network, a public or private database, and the like. The embodiments presented herein provide machine learning models that can process multimedia data in real-time or near real-time so that text transcripts can be generated on-the-fly even as new multimedia content becomes available.

Text analysis module 110 may analyze multimedia data in order to identify and derive any text that is present in the video portion of multimedia data. Text analysis module 110 may analyze each frame of video data to identify the presence of any text in any of the frames. Text analysis module 110 may employ one or more character recognition models to identify text, which can include preprocessing operations (e.g., noise reduction, image normalization, and/or binarization operations, etc.) prior to applying a character recognition model to the video data. Character recognition can be performed by a trained machine learning model, such as a neural networks, Hidden Markov Models (HMM), or Support Vector Machines (SVM). In various embodiments, the model(s) can be trained to identify typed text and/or handwritten text.

When text analysis module 110 derives text, contextual metadata can be obtained that describes the text. The contextual metadata may include a font type, a font size (which can be relative with regard to other text present in the video data), a text formatting (e.g., bold, italics, underline, highlighting, etc.), a case setting (i.e., upper case or lower case), a font color, and the like. Other contextual metadata may include an indication that an effect is applied to the text, such as a flashing animation, a movement animation, and the like. In some embodiments, the contextual metadata may include a number of times that a same or similar text is repeated throughout video data. Additionally or alternatively, the contextual metadata can include any user interactions with text, such as mouse movements by a presenter that are proximal to text, a user selection of text, and the like. Text analysis module 110 may provide the derived text and contextual metadata to other modules of multimedia session server 102, including ranking module 114 and/or NLP module 116.

Entity analysis module 112 can include one or more image processing models that identify any entities in video data, which can include a physical object, person, organism, logo, and the like. An object recognition model may be employed to identify any objects in the video data, such as a vehicle, tool, electronic device, apparel, or any other physical object. Any organisms can be identified, including humans, animals, plants, fungi, etc. Similarly, entity analysis module 112 may identify any logo, trademark, symbol, or other identifier of a brand, organization, concept, and the like. In some embodiments, entity analysis module 112 may identify actions that are depicted in video data using motion detection or other techniques, including interactions between any of the entities identified in the video data. Entity analysis module 112 may identify particular locations or landmarks based on the presence of content in the video data, thus enabling the identities of these locations or landmarks to be used as candidate words for matching to utterances.

In some embodiments, entity analysis module 112 may determine the identity of persons present in video data. A facial recognition model may be employed to analyze facial features of individuals who are present in video data in order to identify those individuals. An identity can be established by matching a face of a person in video data to a face of the person in an identity database, such as a catalog or directory of members of an organization, a database of public figures, and the like. Thus, the identity of a person (i.e., the person's name) can be determined, as well as other data that is descriptive of the person, such as their role in an organization, their interests, responsibilities, and the like.

Entity analysis module 112 may include a machine learning model that is trained to identify a topic of video data based on any entities and/or actions identified in the video data. Topics can include events, such as particular sporting events (e.g., football, tennis, golf, etc.), awards ceremonies, news reports, and the like. In some embodiments, topics can include tones, which can be determined using sentiment analysis of the multimedia data. In order to identify topics, a machine learning model can be trained using multimedia data that is representative of a given topic in order to learn which entities and/or actions are indicative of those topics.

Ranking module 114 may rank candidate words that can be used by NLP module 116 to map to utterances in an audio portion of multimedia data. Candidate words can include any text derived by text analysis module 110 (as well as any other words related to the text) and/or any words that are associated with entities or actions identified by entity analysis module 112. In order to identify words that are related to text that is identified in video data and/or words that are related to entities/actions in video data, a corpus of candidate words can be obtained using a semantic similarity search that employs a vector space model to identify any words that are semantically similar to text in a video and/or the names of objects or actions depicted in video. Thus, a list of candidate words can be provided to ranking module 114 in order to assign scores to words based on the likelihood that they are relevant to, and should accordingly be mapped to, utterances in the audio portion of the multimedia data.

Ranking module 114 may score text that is derived from video data based on the contextual metadata describing the text, which can include font size, repetition of text, user interactions with text, whether or not text is a loan words, jargon, acronym, and the like. In particular, any desired context of derived text that indicates that the text is important or relevant may cause ranking module 114 to assign a score (e.g., a higher score) to the corresponding word(s) indicating that the word(s) are more relevant for the purpose of mapping to utterances by NLP module 116. Ranking module 114 may use any scoring schema, such as a numerical value ranging from one to ten, a multi-dimensional score, and the like, to assign scores to words. Indications that a word obtained from text in video data should be scored as more relevant include the font size being larger than other text, the font type being different from other text, the font having formatting applied, the word repeating in the video data (and the degree to which the word repeats), any other effects applied to the text, and any user interactions with the text, such as mouseover movements, highlighting of text, and the like. In some embodiments, the location of text can be used to score words obtained from the text; for example, text that is in a corner of a video frame may be scored lower than text that is obtained from a center of the video frame. These indications can be additive, so that, for example, a word with a larger font size and which has a formatting applied will be scored as more relevant than a word that merely has a larger font size.

In some embodiments, ranking module 114 can employ a ranking schema that ranks words that are associated with entities identified in video data in combination with text that is derived from the video data. Any words that are associated with entities identified in video data can be scored in a manner that indicates the relevance of the corresponding objects in the video data, which can correspond to the number of frames (e.g., as a percentage) that the entities appear in video and/or the temporal proximity of frames in which the entities are identified to the utterances in the audio data to which the words may be mapped. Thus, if an entity such as a particular person appears frequently in video data, or the entity appears in proximity to an utterance in the audio data that can be mapped to the identity of the entity, these words may be scored accordingly as more relevant to be mapped to a particular utterance. Likewise, landmarks or locations can be assigned a higher score to reflect their relevance, so that words for locations or landmarks are more likely to be mapped to utterances than other common-language homophones.

NLP module 116 may perform speech-to-text processing in order to map utterances in audio data to words. NLP module 116 may be an automatic speech recognition engine that employs one or more machine learning models that are trained to map utterances to words. The machine learning model(s) employed by NLP module 116 may include a hidden Markov model, a deep neural network model, a convolutional neural network model, a recurrent neural network model, a long short-term memory model, a gated recurrent unit model, a transformer-based model, and/or other suitable models, including hybrids of these models. Training data for the machine learning model(s) can include examples of utterances and corresponding words, which can include utterance-word pairs that correspond to text and/or named entities that are identified in video data.

In some embodiments, the list of candidate words for NLP module 116 can include a general lexicon of words in a given language (e.g., English), as well as any proper nouns, jargon or other terminology associated with particular subject matter areas, and the like. In order to map utterances to words, NLP module 116 may consider the scores of words derived from multimedia data in accordance with the present embodiments. In some embodiments, words that are derived from the multimedia data may be assigned a particular score by ranking module 114, and words that are obtained from a general lexicon may be assigned a base value score. For example, in an embodiment in which words can be assigned a score by relevance ranging from one to ten, any words obtained from a general lexicon may be assigned a score of one. Thus, words that are derived from video data may generally receive a higher score indicative of greater relevance as compared to words that are obtained from a general lexicon, thus making NLP module 116 more likely to map a word that is derived from video data to an utterance as compared to mapping a word that is obtained from a general lexicon. As output, NLP module 116 may generate a mapping of utterances to words, which can be used to generate a transcript of a sample of multimedia data.

Database 118 may include any non-volatile storage media known in the art. For example, database 118 can be implemented with a tape library, optical library, one or more independent hard disk drives, or multiple hard disk drives in a redundant array of independent disks (RAID). Similarly, data in database 118 may conform to any suitable storage architecture known in the art, such as a file, a relational database, an object-oriented database, and/or one or more tables. Database 118 may store data including one or more trained machine learning models (e.g., models of NLP module 116, entity recognition models, character recognition models, large language models, etc.). Additionally or alternatively, database 118 can store a mapping of individuals' faces to their identities (e.g., names).

Client devices 120A-120N may each include a network interface (I/F) 122, at least one processor (computer processor) 124, and memory 126 (which stores instructions for a client module 128). In various embodiments, client devices 120A-120N may each include a rack-mounted server, laptop, desktop, smartphone, tablet, or any other programmable electronic device capable of executing computer readable program instructions. Network interface 122 enables components of each client device 120A-120N to send and receive data over a network, such as network 130. Client devices 120A-120N may each enable users to participate in conference sessions in which multimedia data is transmitted (e.g., video presentations).

Client module 128 may include one or more modules or units to perform various functions of the embodiments described below. Client module 128 may be implemented by any combination of any quantity of software and/or hardware modules or units, and may reside within memory 126 of any of client devices 120A-120N for execution by a processor, such as processor 124. Client module 128 may perform various operations to enable a user of each client device 120A-120N to participate in conference sessions by presenting multimedia data to a user, including video data and/or audio data. The multimedia data may also include transcripts of the audio data, which are generated by NLP module 116 and shared to client devices 120A-120N in accordance with the embodiments presented herein.

Network 130 may include a local area network (LAN), a wide area network (WAN) such as the Internet, or a combination of the two, and includes wired, wireless, or fiber optic connections. In general, network 130 can be any combination of connections and protocols known in the art that will support communications between multimedia session server 102 and client devices 120A-120N via their respective network interfaces in accordance with the described embodiments.

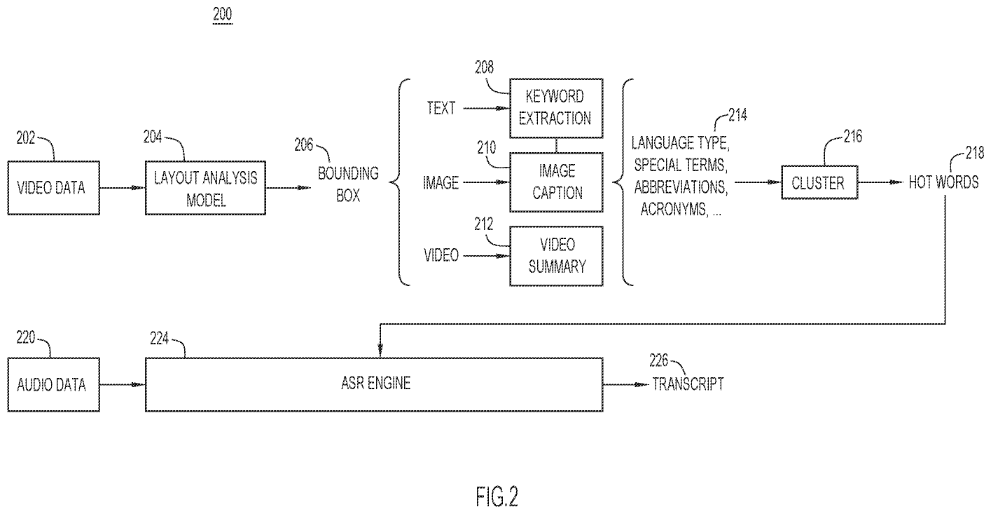

FIG. 2 is a flow diagram for an automatic speech recognition model 200 that generates transcripts, according to an example embodiment. As depicted, automatic speech recognition model 200 processes video data 202 to derive candidate words (e.g., hot words 218), which are provided to an automatic speech recognition (ASR) engine 224 for use in transcribing audio data 220.

Video data 202 and audio data 220 may correspond to corresponding portions of a same multimedia data (e.g., a video, conference session, etc.) that can be live or prerecorded. The video data 202 can be analyzed by layout analysis model 204, which identifies various portions or elements of the video data. Layout analysis model 204 may include one or more machine learning models that are trained to analyze video data 202 with regard to the various portions or elements therein, including regions that have text, entities data, and any regions that correspond to actions, events, themes, etc., in the video data. Layout analysis model 204 may identify a bounding box 206 for each region of the video data, such as a text region, an image region, and other video regions, by performing image processing techniques to divide content from different regions in video data 202 or otherwise derive particular features from the video data 202. For example, in a communication session, a particular region may be identified that includes video content being presented (e.g., a view of a camera, a slideshow presentation, etc.), whereas another region may be identified that includes camera feeds of participants in the communication session. Regions identified by layout analysis model 204 can overlap or reside within other regions; for example, a region that includes an entity may contain a region that includes text superimposed at least partially over the entity.

The regions identified by layout analysis model 204 can each be processed by a particular machine learning model to identify candidate words based on the regions and the content therein. Text can by analyzed to perform keyword extraction 208, image data can be analyzed to provide an image caption 210 describing entities depicted in frames of video data 202, and the video data can be processed in part and/or in whole to generate a video summary 212 of actions, events, topics, etc., that are presented in the video data. Keyword extraction 208 may be performed by a machine learning model that is trained to perform character recognition in order to identify words present in video data 202. In some embodiments, a generative machine learning model may be employed to generate additional words that are associated with any words derived from text present in video data 202. For example, if an derived word is “router,” then a generative machine learning model may output additional related words like “network,” “data” “gateway,” “switch,” “firewall,” and the like. The image caption 210 that is generated for images in the video data 202 may include a word or phrase describing each entity present in the video data 202. These words can be generated by a convolutional neural network that is trained to identify entities in images (e.g., frames of video data 202), including any persons, organisms, objects, and the like. The video summary 212 may be generated using a neural network (such as a recurrent neural network, convolutional neural network, etc.), a long short-term memory network, or other machine learning model that is trained to generate a video summary 212 that includes text describing the content of video. Similarly to the words generated based on keyword extraction 208, the words obtained from image caption 210 and the video summary 212 can be expanded using a generative model that outputs additional related words.

The words that are obtained from keyword extraction 208, the image caption 210, and the video summary 212 may be provided as output 214, which can include as metadata a language type (e.g., English, etc.), as well as the words themselves, which can include special terms (e.g., jargon), abbreviations, acronyms, names of persons, and the like. This output 214 can be organized as a cluster 216 in which the words of output 214 are represented as word embeddings in a vector space model. By analyzing cluster 216 to identify words that are closely related (e.g., via a similarity measure such as cosine similarity), hot words 218 can be derived as the candidate words that are most closely related to each other, and therefore, which may be most relevant for mapping to utterances in the audio data 220.

The hot words 218 can be provided to ASR engine 224 along with the audio data 220 in order to map utterances to words. ASR engine 224 may utilize a corpus of general vocabulary words for mapping utterances to words that is augmented with the hot words 218. The hot words 218 may be scored in accordance with present embodiments so that any words available for mapping to utterances can be ranked according to each other in a manner that is considered by ASR engine 224 when selecting a particular word to map to an utterance. Thus, more relevant words are more likely to be mapped to a particular utterance when there is an ambiguity (e.g., homophones, words that sounds similar to proper nouns or acronyms, etc.). As output, ASR engine may generate a transcript 226 of the audio data 220 that includes text corresponding to any utterances in the audio data. This transcript 226 can be inserted into the multimedia data as a closed captioning or otherwise provided to consumers of the multimedia data. In some embodiments, the transcript 226 is generated in a time-series format and can be used for indexing multimedia data to make the multimedia data searchable (e.g., to find particular portions of video data in which certain query keywords are discussed).

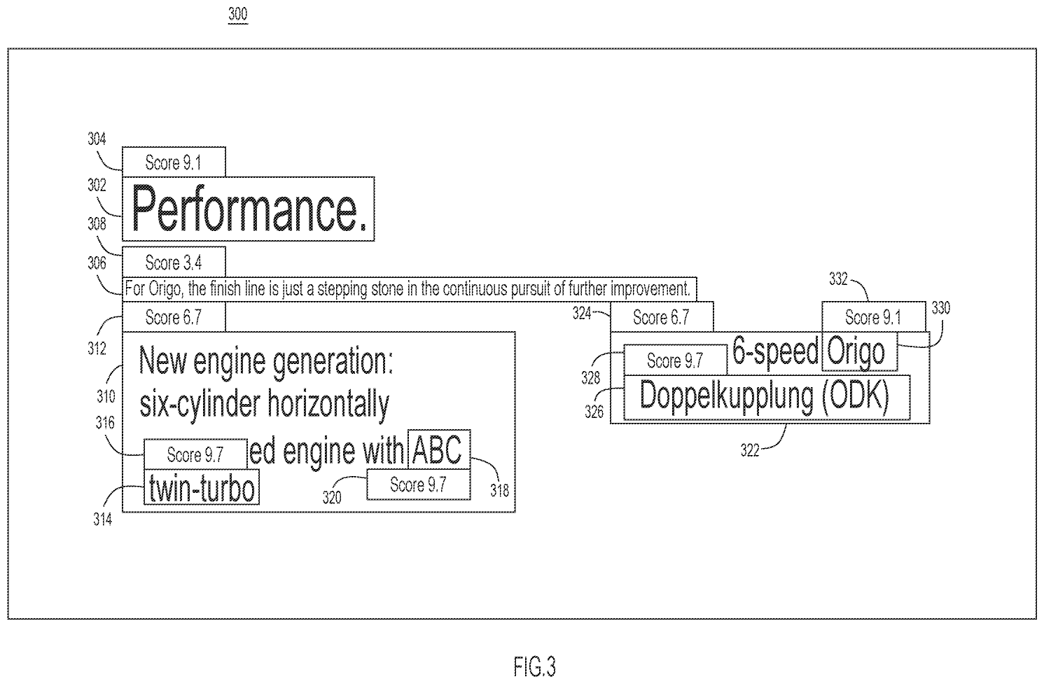

FIG. 3 is a diagram depicting video content 300 that is analyzed according to an example embodiment. As depicted, text that is overlaying the video data is extracted and scored. In particular, text 302 (“Performance.”), text 306 (“For Origo, the finish line . . . ”), text 310 (“New engine generation . . . ”), and text 322 (“New S-speed Origo . . . ”) is provided. Additionally, text 310 and text 322 includes subcomponents that are also identified based on certain features, including text 318 (“ABC”), text 314 (“twin-turbo”), text 326 (“Doppelkupplung (ODK)”) and text 330 (“Origo”). Text 318 may be separately identified due to the presence of an acronym, whereas text 314 may be identified due to the presence of a technical term. Moreover, text 326 may be identified due to the presence of a foreign word (“Doppelkupplung”) and/or an acronym (“ODK”), and text 330 may be identified due to the presence of a proper noun (“Origo”).

Each text 302, 306, 310, 314, 318, 326, and 330 may be scored according to the embodiments presented herein. The scores 304, 308, 312, 316, 320, 324, 328, and 332 may be relative to each other; it should be appreciated that any scoring schema can be employed that is suitable for ranking the relevance of words relative to each other in accordance with present embodiments. In the depicted example, a higher score indicates a word that is deemed as more relevant for the purposes of matching candidate words to utterances in corresponding audio data. Accordingly, text 302 may be provided with score 304 that indicates a relatively high relevance due to the size of the font of text 302 relative to the rest of the text. Text 306 may be provided with score 308 that reflects a relatively low relevance due to the size of the font relative to other text present in video content 300.

Text 310 may be provided with a score 312 that indicates a medium relevance due to the intermediate size of the font relative to other text. However, the presence of certain words, acronyms, or other features may cause additional text within text 310 to be identified and scored. In the depicted example, text 314 is identified and scored with score 316 indicating a high relevance score due to the presence of a technical term. Additionally, text 318 may be identified and provided with a score 320 also indicating a high relevance due to the presence of an acronym.

With further reference to the example embodiment of FIG. 3, text 322 may be provided with a score 324 that indicates a medium relevance due to the font size of text 322. Text 326 and 330, which are included in text 322, may be separately identified and analyzed due to the presence of particular features. Regarding text 326, a foreign language word and acronym may cause text 326 to be scored with a score 328 indicating a high relevance. Text 330, which includes a proper noun, may be scored with score 332 indicating a high relevance. The text 302, 306, 310, 314, 318, 326, and 330 and corresponding scores 304, 308, 312, 316, 320, 324, 328, and 332 may be provided to an automatic speech recognition model for usage as input, along with a general corpus of vocabulary words, when performing speech-to-text processing of audio that corresponds to video content 300.

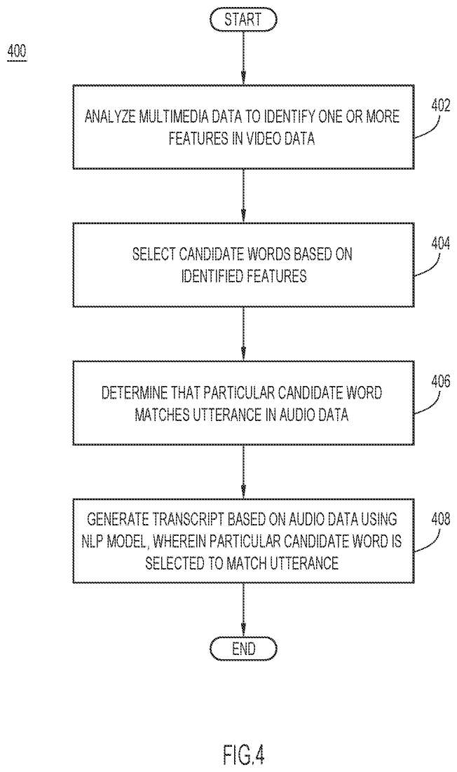

FIG. 4 is a flow chart of a method 400 for performing automatic speech recognition with respect to multimedia data, according to an example embodiment.

Multimedia data is analyzed to identify one or more features in the video data at operation 402. The multimedia data can include video data and corresponding audio data; the video data is analyzed to identify a context for words that are to be matched to utterances in the audio data by performing text derivation, entity identification, and other operations. The features that are identified in the video data can include any text present in the video data, any entities or actions performed in the video data, and any topics, themes, and the like that are present in the video data. The identities of persons present in the video data can be identified, as well as identities of proper nouns present in the video data. Any words derived from the video data can be used to generate additional words using a generative machine learning model that is trained to generate lists of vocabulary words that are related to a particular input word. Thus, for example, an input word of “GPU” (e.g., an acronym for graphical processing unit) may be used to obtain words such as “memory,” “cache,” “graphics,” and the like.

Candidate words are selected based on identified features at operation 404. The candidate words can be ranked according to scores provided to each candidate word, which can include the size and location of text relative to other text in the video data, as well as any formatting applied to the text, the presence of acronyms, proper nouns, and the like. Entities, actions, topics, and the like can also be identified in the video data in order to score words obtained from these identified features. Candidate words that relate to non-text features in the video data (e.g., entities, actions, etc.) can be ranked according to how predominantly those non-text features are present in the video data (e.g., a number of frames in which each feature is present, etc.).

Operation 406 determines that a particular candidate word matches an utterance in the audio data. An automatic speech recognition model may be trained to match words to utterances by receiving as input candidate words that are scored according to their relevance in the video data. The automatic speech recognition model may also receive a general lexicon of words that can be scored with a lower score to indicate that they may not be as relevant. When the automatic speech recognition model receives an utterance, the automatic speech recognition model may consider the closeness to which the utterance matches a word, and can use the scores of each word to rank the words in order to more accurately select a word to match to the utterance. For example, in the context of a GPU, an utterance can be more accurately mapped to “cache” rather than “cash,” as the score for “cache” may be higher than “cash” in the given context. For names, a name that sounds like another word may be more highly scored if a person having that name is present in the video data. Thus, an utterance may be mapped to “Jim” rather than “gym” if a person named “Jim” is present in the video data.

A transcript is generated at operation 408 that is based on audio data using an NLP model, wherein a particular candidate word is selected to matches an utterance. The transcript may include a listing of words that are mapped to utterances in the chronological order of the utterances. Thus, the transcript may match the audio portion of the input multimedia data.

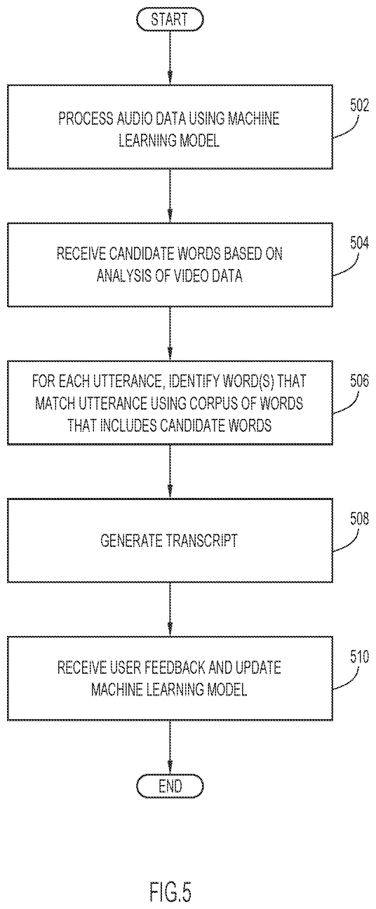

FIG. 5 is a flow chart of a method 500 for mapping utterances to text, according to an example embodiment.

Audio data is processed using a machine learning model at operation 502. The audio data is processed by a natural language processing algorithm in order to derive individual utterances in the audio data so that words can be mapped to those utterances. The natural language processing algorithm may include a machine learning model that is trained to detect utterances in a particular language (e.g., English) or multiple languages.

Candidate words are received that are based on an analysis of the video data at operation 504. The candidate words can include any words derived from video data, including words corresponding to text in the video data, words associated with entities, actions, landmarks, locations, events, actions, or other words relating to any content in the video data. Additionally, the candidate words can include a general lexicon of words in a particular language (e.g., English), such as a dictionary listing of any desired words.

For each utterance, one or more words are identified that match the utterance using a corpus of words that includes the candidate words at operation 506. Each word may be assigned a score that indicates the relevance of the word with regard to the video data. In particular, words from a general lexicon may be assigned a low score, and any words that are derived from the video data can be scored according to the relevance of the features from which those words are obtained. Thus, candidate words that relate to content in video data may be scored with a score indicative of higher relevance, meaning that those words can be ranked as more relevant than other potential candidate words that match an utterance. When a natural language processing model is provided with an utterance, a subset of candidate words can be selected that generally match the utterance, and then the scores of each word in the subset of candidate words can be used to rank those words and to select a word in particular based on its ranking. Thus, a word that is more relevant to the video data may be selectively mapped to an utterance over another word that is not as relevant.

This process can be repeated for each utterance in audio data in order to generate a transcript for multimedia data at operation 508. The transcript can be associated with the multimedia data so that the transcript can be read either independently or by a user who is consuming the multimedia data. The transcript may include timestamps for one or more words to indicate the points at which words in the transcript align with playback of the video data.

User feedback is received and the machine learning model is updated at operation 510. The user feedback can include indications of whether or not a particular word matches a particular utterance. The user feedback can be used to retrain the various machine learning models employed herein in order to more accurately match words to utterances. In particular, a machine learning model that provides the scoring mechanism for words can be retrained in order to more accurately score words as more or less relevant, thus increasing the likelihood that words are more accurately matched to utterances.

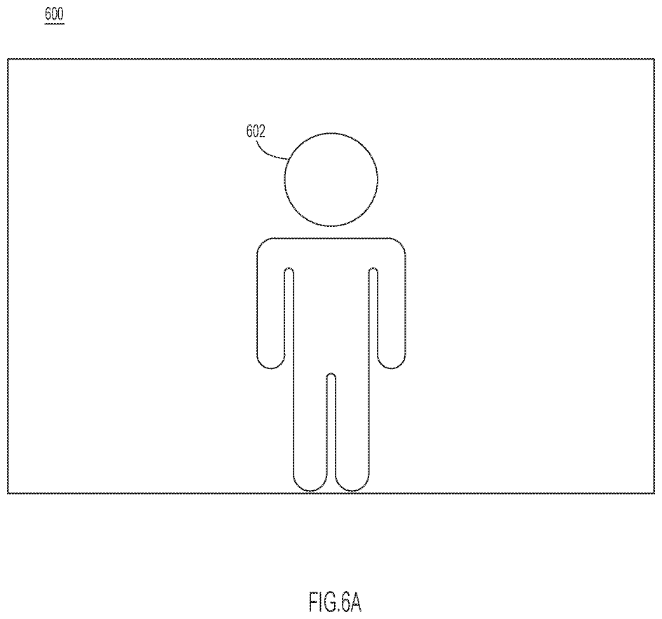

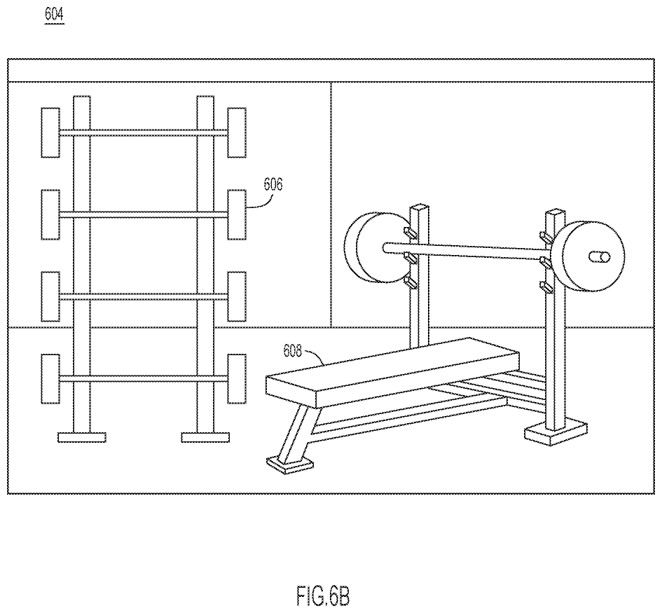

FIGS. 6A and 6B are diagrams depicting image data 600 and 604 corresponding to different multimedia data samples, according to an example embodiment. As depicted, image data 600 (e.g., from video) is obtained from a first multimedia data sample, and depicts a person 602. Image data 604 (e.g., from video) is obtained from a second multimedia data sample, and depicts a gymnasium having weights 606 and a bench 608. By applying entity recognition techniques in accordance with the embodiments presented herein, the identity of the person 602 can be determined to be a person named “Jim.” Similarly, image data 604 can be processed to identify that the setting is a gymnasium based on the presence of identified entities including the weights 606 and/or the bench 608. Thus, candidate words that are derived from image data 600 may include the word “Jim,” whereas candidate words that are derived from image data 604 may include the word “gym.” Accordingly, when mapping words to an utterance in the first multimedia data sample, the word “Jim” may be provided to an automatic speech recognition system. In contrast, the word “gym” may be provided to an automatic speech recognition system when mapping utterances to words in the second multimedia data sample. Thus, despite being homophones, “gym” and “Jim” may be mapped to the correct utterance in each multimedia sample given the context that is obtained by processing the respective video data of each multimedia sample.

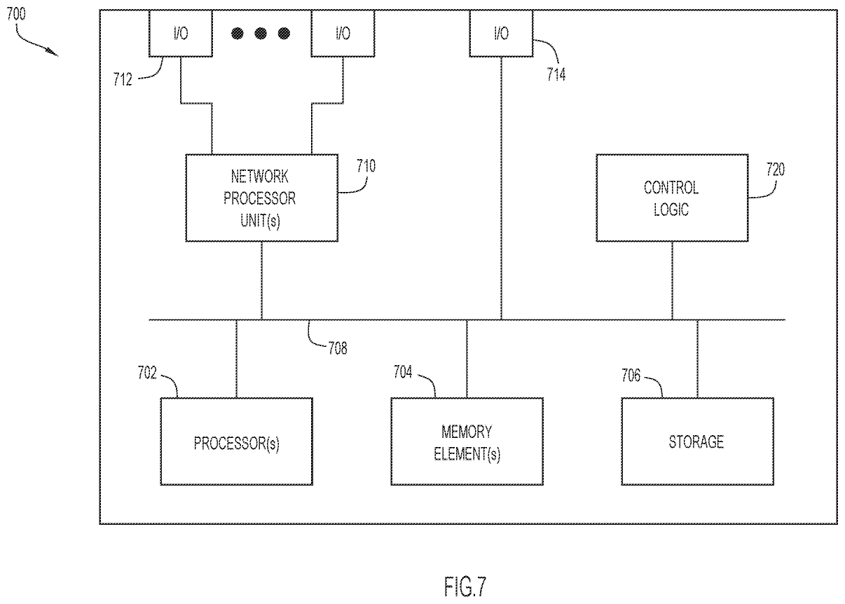

Referring now to FIG. 7, FIG. 7 illustrates a hardware block diagram of a computing device 700 that may perform functions associated with operations discussed herein in connection with the techniques depicted in FIGS. 1-6B. In at least one embodiment, the computing device 700 may include one or more processor(s) 702, one or more memory element(s) 704, storage 706, a bus 708, one or more network processor unit(s) 710 interconnected with one or more network input/output (I/O) interface(s) 712, one or more I/O 714, and control logic 720. In various embodiments, instructions associated with logic for computing device 700 can overlap in any manner and are not limited to the specific allocation of instructions and/or operations described herein.

In at least one embodiment, processor(s) 702 is/are at least one hardware processor configured to execute various tasks, operations and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 704 and/or storage 706 is/are configured to store data, information, software, and/or instructions associated with computing device 700, and/or logic configured for memory element(s) 704 and/or storage 706. For example, any logic described herein (e.g., control logic 720) can, in various embodiments, be stored for computing device 700 using any combination of memory element(s) 704 and/or storage 706. Note that in some embodiments, storage 706 can be consolidated with memory element(s) 704 (or vice versa), or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between computing device 700 and other systems, entities, etc., via network I/O interface(s) 712 (wired and/or wireless) to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interface(s) 712 may include suitable interfaces for receiving, transmitting, and/or otherwise communicating data and/or information in a network environment.

I/O 714 allow for input and output of data and/or information with other entities that may be connected to computing device 700. For example, I/O 714 may provide a connection to external devices such as a keyboard, keypad, mouse, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 602.11 (e.g., Wi-Fi®/Wi-Fi6®), IEEE 602.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein.

Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In some aspects, the techniques described herein relate to a computer-implemented method including: analyzing multimedia data including video data and audio data associated with the video data to identify one or more features in the video data; obtaining one or more candidate words based on the one or more features identified in the video data; determining that a particular candidate word of the one or more candidate words matches a particular utterance in the audio data; and selecting the particular candidate word for the particular utterance based on the audio data.

In some aspects, the techniques described herein relate to a computer-implemented method, further including: determining a relevance score for each of the one or more candidate words based on a context of the one or more features; and ranking the one or more candidate words according to the relevance score of each candidate word, wherein the particular candidate word is selected based on the ranking of the one or more candidate words.

In some aspects, the techniques described herein relate to a computer-implemented method, wherein the one or more features identified in the video data include text, and wherein the context that is used to determine the relevance score for each candidate word includes one or more of: a position of the text, a font size of the text, a letter case of the text, and an acronym status of the text.

In some aspects, the techniques described herein relate to a computer-implemented method, wherein the context of the one or more features includes one or more of: a position of the one or more features in the video data, and a user interaction with respect to the one or more features.

In some aspects, the techniques described herein relate to a computer-implemented method, wherein the one or more features identified in the video data include a physical entity or object, a location, a logo, or an action depicted in the video data, and wherein the one or more candidate words are obtained from a corpus of words that are semantically related to the physical entity or object, the location, the logo, or the action.

In some aspects, the techniques described herein relate to a computer-implemented method, wherein the one or more features identified in the video data include a person, and wherein a facial recognition model is employed to identify the person and the one or more candidate words are obtained based on an identity of the person.

In some aspects, the techniques described herein relate to a computer-implemented method, further including: identifying a topic of at least a portion of the multimedia data, and wherein the one or more candidate words are obtained from a corpus of words that are semantically related to the topic.

In some aspects, the techniques described herein relate to a computer-implemented method, wherein obtaining the one or more candidate words includes providing the one or more features to a large language model that generates a corpus of words relating to the one or more features, and wherein the one or more candidate words are selected from the corpus of words.

In some aspects, the techniques described herein relate to a computer-implemented method, further including generating a transcript or closed-caption text for the multimedia data based on the selecting of the particular candidate word.

In some aspects, the techniques described herein relate to a system including: one or more computer processors; one or more computer readable storage media; and program instructions stored on the one or more computer readable storage media for execution by at least one of the one or more computer processors, the program instructions including instructions to: analyze multimedia data including video data and audio data associated with the video data to identify one or more features in the video data; obtain one or more candidate words based on the one or more features identified in the video data; determine that a particular candidate word of the one or more candidate words matches a particular utterance in the audio data; and select the particular candidate word for the particular utterance based on the audio data.

In some aspects, the techniques described herein relate to a system, wherein the program instructions further include instructions to: determine a relevance score for each of the one or more candidate words based on a context of the one or more features; and rank the one or more candidate words according to the relevance score of each candidate word, wherein the particular candidate word is selected based on the ranking of the one or more candidate words.

In some aspects, the techniques described herein relate to a system, wherein the one or more features identified in the video data include text, and wherein the context that is used to determine the relevance score for each candidate word includes one or more of: a position of the text, a font size of the text, a letter case of the text, and an acronym status of the text.

In some aspects, the techniques described herein relate to a system, wherein the context of the one or more features includes one or more of: a position of the one or more features in the video data, and a user interaction with respect to the one or more features.

In some aspects, the techniques described herein relate to a system, wherein the one or more features identified in the video data include a physical entity or object, a location, a logo, or an action depicted in the video data, and wherein the one or more candidate words are obtained from a corpus of words that are semantically related to the physical entity or object, the location, the logo, or the action.

In some aspects, the techniques described herein relate to a system, wherein the one or more features identified in the video data include a person, and wherein a facial recognition model is employed to identify the person and the one or more candidate words are obtained based on an identity of the person.

In some aspects, the techniques described herein relate to a system, wherein the program instructions further include instructions to: identify a topic of at least a portion of the multimedia data, and wherein the one or more candidate words are obtained from a corpus of words that are semantically related to the topic.

In some aspects, the techniques described herein relate to one or more non-transitory computer readable storage media having program instructions embodied therewith, the program instructions executable by a computer to cause the computer to perform operations including: analyzing multimedia data including video data and audio data associated with the video data to identify one or more features in the video data; obtaining one or more candidate words based on the one or more features identified in the video data; determining that a particular candidate word of the one or more candidate words matches a particular utterance in the audio data; and selecting the particular candidate word for the particular utterance based on the audio data.

In some aspects, the techniques described herein relate to one or more non-transitory computer readable storage media, wherein the program instructions further cause the computer to perform operations including: determining a relevance score for each of the one or more candidate words based on a context of the one or more features; and ranking the one or more candidate words according to the relevance score of each candidate word, wherein the particular candidate word is selected based on the ranking of the one or more candidate words.

In some aspects, the techniques described herein relate to one or more non-transitory computer readable storage media, wherein the one or more features identified in the video data include text, and wherein the context that is used to determine the relevance score for each candidate word includes one or more of: a position of the text, a font size of the text, a letter case of the text, and an acronym status of the text.

In some aspects, the techniques described herein relate to one or more non-transitory computer readable storage media, wherein the context of the one or more features includes one or more of: a position of the one or more features in the video data, and a user interaction with respect to the one or more features.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A computer-implemented method comprising:
analyzing multimedia data including video data and audio data associated with the video data to identify one or more features in the video data;
obtaining one or more candidate words based on the one or more features identified in the video data;
determining that a particular candidate word of the one or more candidate words matches a particular utterance in the audio data; and
selecting the particular candidate word for the particular utterance based on the audio data.

2. The computer-implemented method of claim 1, further comprising:
determining a relevance score for each of the one or more candidate words based on a context of the one or more features; and
ranking the one or more candidate words according to the relevance score of each candidate word,
wherein the particular candidate word is selected based on the ranking of the one or more candidate words.

3. The computer-implemented method of claim 2, wherein the one or more features identified in the video data include text, and wherein the context that is used to determine the relevance score for each candidate word includes one or more of: a position of the text, a font size of the text, a letter case of the text, and an acronym status of the text.

4. The computer-implemented method of claim 2, wherein the context of the one or more features includes one or more of: a position of the one or more features in the video data, and a user interaction with respect to the one or more features.

5. The computer-implemented method of claim 1, wherein the one or more features identified in the video data include a physical entity or object, a location, a logo, or an action depicted in the video data, and wherein the one or more candidate words are obtained from a corpus of words that are semantically related to the physical entity or object, the location, the logo, or the action.

6. The computer-implemented method of claim 1, wherein the one or more features identified in the video data include a person, and wherein a facial recognition model is employed to identify the person and the one or more candidate words are obtained based on an identity of the person.

7. The computer-implemented method of claim 1, further comprising:
identifying a topic of at least a portion of the multimedia data,
wherein the one or more candidate words are obtained from a corpus of words that are semantically related to the topic.

8. The computer-implemented method of claim 1, wherein obtaining the one or more candidate words includes providing the one or more features to a large language model that generates a corpus of words relating to the one or more features, and wherein the one or more candidate words are selected from the corpus of words.

9. The computer-implemented method of claim 1, further comprising generating a transcript or closed-caption text for the multimedia data based on the selecting of the particular candidate word.

10. A system comprising:
one or more computer processors;
one or more computer readable storage media; and
program instructions stored on the one or more computer readable storage media for execution by at least one of the one or more computer processors, the program instructions comprising instructions to:
analyze multimedia data including video data and audio data associated with the video data to identify one or more features in the video data;
obtain one or more candidate words based on the one or more features identified in the video data;
determine that a particular candidate word of the one or more candidate words matches a particular utterance in the audio data; and
select the particular candidate word for the particular utterance based on the audio data.

11. The system of claim 10, wherein the program instructions further comprise instructions to:
determine a relevance score for each of the one or more candidate words based on a context of the one or more features; and
rank the one or more candidate words according to the relevance score of each candidate word,
wherein the particular candidate word is selected based on the ranking of the one or more candidate words.

12. The system of claim 11, wherein the one or more features identified in the video data include text, and wherein the context that is used to determine the relevance score for each candidate word includes one or more of: a position of the text, a font size of the text, a letter case of the text, and an acronym status of the text.

13. The system of claim 11, wherein the context of the one or more features includes one or more of: a position of the one or more features in the video data, and a user interaction with respect to the one or more features.

14. The system of claim 10, wherein the one or more features identified in the video data include a physical entity or object, a location, a logo, or an action depicted in the video data, and wherein the one or more candidate words are obtained from a corpus of words that are semantically related to the physical entity or object, the location, the logo, or the action.

15. The system of claim 10, wherein the one or more features identified in the video data include a person, and wherein a facial recognition model is employed to identify the person and the one or more candidate words are obtained based on an identity of the person.

16. The system of claim 10, wherein the program instructions further comprise instructions to:
identify a topic of at least a portion of the multimedia data,
wherein the one or more candidate words are obtained from a corpus of words that are semantically related to the topic.

17. One or more non-transitory computer readable storage media having program instructions embodied therewith, the program instructions executable by a computer to cause the computer to perform operations including:
analyzing multimedia data including video data and audio data associated with the video data to identify one or more features in the video data;
obtaining one or more candidate words based on the one or more features identified in the video data;
determining that a particular candidate word of the one or more candidate words matches a particular utterance in the audio data; and
selecting the particular candidate word for the particular utterance based on the audio data.

18. The one or more non-transitory computer readable storage media of claim 17, wherein the program instructions further cause the computer to perform operations including:
determining a relevance score for each of the one or more candidate words based on a context of the one or more features; and
ranking the one or more candidate words according to the relevance score of each candidate word,
wherein the particular candidate word is selected based on the ranking of the one or more candidate words.

19. The one or more non-transitory computer readable storage media of claim 18, wherein the one or more features identified in the video data include text, and wherein the context that is used to determine the relevance score for each candidate word includes one or more of: a position of the text, a font size of the text, a letter case of the text, and an acronym status of the text.

20. The one or more non-transitory computer readable storage media of claim 18, wherein the context of the one or more features includes one or more of: a position of the one or more features in the video data, and a user interaction with respect to the one or more features.
